(19) United States
(12) Patent Application Publication
(10) Pub. No.: US 2025/0066691 A1
(43) Pub. Date: Feb. 27, 2025

(54) SOLVENT-BASED DETERGENT COMPOSITIONS AND METHODS FOR HYDROPHOBIC SOIL REMOVAL

(71) Applicant: ECOLAB USA INC., Saint Paul, MN (US)

(72) Inventor: Alex Robert Pederson, Minneapolis, MN (US)

(21) Appl. No.: 18/802,080

(22) Filed: Aug. 13, 2024

Related U.S. Application Data
(60) Provisional application No. 63/578,686, filed on Aug. 25, 2023.

(51) Int. Cl. C11D 1/66; C11D 1/90; C11D 3/00; C11D 3/43

(52) U.S. Cl. CPC C11D 1/66; C11D 1/90; C11D 3/0036; C11D 3/43

(57) ABSTRACT

Detergent and cleaning compositions for removal hydrophobic soils including cosmetic soils are described herein. The detergent and cleaning compositions include an insoluble solvent and surfactants to formulate the insoluble solvents in compositions at low concentrations overcoming various challenges in formulating with insoluble solvents. Methods of using the various compositions are also described to provide beneficial improvements in the ability to clean and remove challenging hydrophobic soils.

### CROSS REFERENCE TO RELATED APPLICATIONS

This application claims priority under 35 U.S.C. § 119 to provisional patent application U.S. Ser. No. 63/578,686, filed Aug. 25, 2023. The provisional patent application is herein incorporated by reference in its entirety.

### TECHNICAL FIELD

The disclosure relates generally to detergent and cleaning compositions for removal hydrophobic soils. More particularly, the present disclosure relates to a detergent and cleaning compositions comprising insoluble solvents and surfactants to formulate the insoluble solvents in compositions at low concentrations overcoming various challenges in formulating with insoluble solvents. Methods of using the various compositions are also provided, including applications of use in removing challenging hydrophobic soils such as various cosmetic products, deodorants, sun protection, and the like which are known to be difficult to remove using conventional aqueous-based detergent and cleaning compositions.

### BACKGROUND

The cleaning and removal of soils, such as various cosmetic products, deodorants, sun protection, and the like present challenges as many of these soils are insoluble to promote long lasting effects. Cosmetic soils, including those on cosmetic manufacturing equipment, are an example of this soil removal challenge as the soils are difficult to penetrate and emulsify. Larges varieties of manufacturing equipment for all kinds of different cosmetics products, along with other surfaces (e.g. laundry) soils with these products, require cleaning.

The cosmetics industry most often uses alkaline or acidic cleaning products for its manufacturing equipment. Traditionally, aqueous based alkaline or acidic detergent compositions are used in industrial cleaning processes. These detergents typically include either an alkaline or acid source as well as a blend of components that can include surfactants, chelants, sequestrants, dispersants, coupling agents, polar solvents with high water solubility, and other functional ingredients.

These alkaline or acidic cleaning products are also not equally performing on all kinds of cosmetics soils. As a result, a manufacturer who makes many different cosmetics products must either purchase many different cleaning products to effectively remove soils and/or achieves ineffective cleaning of all soils. In addition, the fast-moving cosmetics industry requires manufacturers to frequently modify existing products, which may also require modified cleaning products and procedures to avoid insufficient soil removal. It is not uncommon in the cosmetic industry for there to be insufficient cleaning and detergent compositions. As a result, there are not cost-effective cleaning and detergent compositions, nor are there many options for detergent and cleaning compositions.

In addition, although aqueous detergents are effective at cleaning water soluble soils, and some oils or fats that can be emulsified, there are significant limitations that arise when the soils include components that are very water insoluble and difficult to emulsify. In these instances, solvents are typically needed. However, solvents typically cannot be diluted in water and instead are used at 100% concentration. Solvents can also be dangerous due to high flammability. Still further, solvents are not sustainable and biodegradable products.

It is therefore an object of the present disclosure to provide detergent and cleaning compositions to remove hydrophobic soils.

It is a further object of the disclosure to provide efficacious detergent and cleaning compositions employing insoluble solvents providing formulation benefits, safety benefits, and sustainability benefits.

It is a further object of the disclosure to provide detergent and cleaning compositions providing superior efficacy compared to traditional solvents, namely polar solvents having high water solubility and lacking the defined ranges of Log P and total polar surface area as described herein according to the invention.

It is yet another object of this disclosure to provide methods of cleaning using the detergent and cleaning compositions that allows manufacturing equipment of all kinds of different cosmetics products (and other insoluble products or those challenging to emulsify) to be cleaned.

Other objects, aspects and advantages of this invention will be apparent to one skilled in the art in view of the following disclosure, the drawings, and the appended claims.

### SUMMARY

It is a primary object, feature, and/or advantage of the present disclosure to improve on or overcome the deficiencies in the art in cleaning and removing various hydrophobic soils, such as cosmetic soils. It is an advantage of the detergent and cleaning compositions to combine a hydrophobic solvent and surfactant into a composition to replace conventional solvents that are incapable of removing hydrophobic soils. This advantage is further provided in the methods of cleaning using the detergent and cleaning compositions, whereby soils that are very water insoluble and difficult to emulsify can be cleaned and removed. A still further advantage is the ability to employ solvents that are diluted instead of used at 100% concentration, overcoming formulation, safety and sustainability challenges.

According to some aspects of the present disclosure, detergent and cleaning compositions comprise: an insoluble solvent; and an alkyl polyglycoside surfactant and a co-surfactant or co-solvent to provide an emulsion.

According to some additional aspects of the present disclosure, methods of use comprise: applying the composition as described herein to a surface in need of soil removal, wherein the soil is hydrophobic and/or oily soil; and removing the soil.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an exemplary visual scoring system for visual assessment of soil removal as described herein the Examples.

FIG. 2 is a graph describing evaluated solvents with measures of solubility and polarity with Log P and Topological Polar Surface Area as described herein the Examples.

FIG. 3 is a graph indicating the visual scoring of soiled coupons after cleaning with commercially available products and an exemplary formula as described herein the Examples.

FIG. 4 shows the visual assessment of soiled coupons before and after cleaning as described herein the Examples.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4%. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, surface tension, molecular weight, contact angle, temperature, pH, humidity, molar ratios, log count of bacteria or viruses, and any other measurement or the like described herein. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “between” is inclusive of any endpoints noted relative to a described range.

As used herein, the term “cleaning” refers to a method used to facilitate or aid in soil removal, soil emulsification and/or dissolving of soils, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

As used herein, the term “exemplary” refers to an example, an instance, or an illustration, and does not indicate a most preferred embodiment unless otherwise stated.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

The term “hard surface” refers to a solid, substantially non-flexible surface such as but not limited to a countertop, tile, floor, wall, panel, window, plumbing fixture (e.g. drain), kitchen and bathroom furniture, manufacturing furniture, appliance, engine, circuit board, dish, mirror, window, monitor, touch screen, instruments, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soft surface” refers to surfaces not classified as hard surfaces, but which are solid surfaces. Soft surfaces, include, but are not limited to, textiles, fabrics, woven surfaces, and non-woven surfaces. Soft surfaces, include, but are not limited to, carpet, curtains, fabrics, hospital partitions, linens, and upholstery.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc. Soils can further include inorganic soils and salts, as well as dyes and pigments.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Compositions

According to embodiments, the detergent and cleaning compositions include an insoluble solvent and surfactants, and optionally additional functional ingredients. The compositions can include additional functional ingredients and can be provided as concentrate or use compositions. Exemplary compositions are shown in Tables 1A and 1B in weight percentages. While the components may have a percent actives of 100%, it is noted that Tables 1A and 1B do not recite the percent actives of the components, but rather, recites the total weight percentage of the raw materials (i.e. active concentration plus inert ingredients).

TABLE 1A

| | First | Second | Third |
|---|---|---|---|
| | Exemplary | Exemplary | Exemplary |
| Material | Range wt.-% | Range wt.-% | Range wt.-% |
| Insoluble Solvent | 10-80 | 15-80 | 15-70 |
| Surfactant(s) | 1-80 | 1-70 | 10-60 |
| Chelant | 0-30 | 0-30 | 1-30 |
| Additional Functional | 0-50 | 0-40 | 0-30 |
| Ingredients | | | |
| Total | 100 | 100 | 100 |

TABLE 1B

| | First | Second | Third |
|---|---|---|---|
| | Exemplary | Exemplary | Exemplary |
| Material | Range wt.-% | Range wt.-% | Range wt.-% |
| Insoluble Solvent | 10-80 | 15-80 | 15-70 |
| APG Surfactant | 1-80 | 5-60 | 5-50 |
| Amphoteric Co- | 1-80 | 5-60 | 10-50 |
| Surfactant and/or Co- | | | |
| Solvent | | | |
| Chelant | 0-30 | 0-30 | 1-30 |
| Additional Functional | 0-50 | 0-40 | 0-30 |
| Ingredients | | | |
| Total | 100 | 100 | 100 |

The detergent and cleaning compositions are an emulsion, which is a mixture of two or more immiscible liquids having varying stability at different concentrations, temperatures, and alkalinity levels. In embodiments the detergent cand cleaning compositions are combined with a diluent, e.g. water added to the emulsion to provide a concentration diluted in water at about 0.5-20% concentration, about 1-10% concentration, or preferably about 1-6% concentration at some point in the method and can be further mixed or agitated to maintain dispersion. The detergent and cleaning compositions remain in an emulsion during use that balances the challenges in stabilizing the insoluble solvents while also ensuring soil access to the solvents for cleaning. Over emulsification can negatively impact soil removal (i.e. performance) by limiting access of the insoluble solvent to the soils themselves.

The compositions have an appropriately neutral pH between about 6 to about 9. The compositions are beneficially biodegradable, safe to use, soft metal safe (also referred to as soft metal compatible), and have low VOC (volatile organic compound) amounts than commercially available detergent compositions. In preferred embodiments the compositions meet EPA requirements for vapor pressure measured at 20° C. (i.e. 0.0 mbar for 2-ethylhexyl lactate) and the boiling point (i.e. approx. 243° C. for 2-ethylhexyl lactate). The compositions employing the insoluble solvents provider low vapor pressure and high boiling points providing a low VOC.

Beneficially the compositions allow formulation with insoluble solvents to provide efficacious cleaning with surfactant(s) at low concentrations without needing to use water as a diluent. In some embodiments the emulsion compositions do not add water as diluent or solvent (separate from any water from aqueous components of raw materials). In an embodiment the concentrated compositions (total components in the formulation) are at a concentration diluted in water at about 0.5-20% concentration, about 1-10% concentration, or preferably about 1-6% concentration.

### Insoluble Solvent

The detergent and cleaning compositions include an insoluble solvent. As described herein insoluble solvents refer to a solvent which is incapable of forming a solution with another substance or substances. The insoluble solvents include at least one polar functional group. Exemplary polar functional groups include hydroxyl, methyl, carboxyl, carbonyl, amino, or phosphate groups. Such insoluble solvents that include the exemplary polar functional groups may include, but are not limited to, glycol ether solvents, alcohol solvents, ester solvents, fatty acid solvents, distillates (petroleum), and mixtures thereof.

The insoluble solvents can further be defined according to a partition coefficient, P, that is defined as the ratio of the equilibrium concentrations, C, of a dissolved chemical in a two-phase system consisting of two immiscible solvents. The logarithm of the partition coefficient, Log P, describes the hydrophobicity of solvents. According to the embodiments of the description, the insoluble solvents vary in water solubility which can be assessed by the solvent's Log P, as described above, wherein a higher Log P indicates a less soluble solvent. In an embodiment the insoluble solvent has a Log P≥1.75, and in some challenging soil removal embodiments a Log P of ≥4.

The insoluble solvents can further be defined according to topological polar surface area is the amount of molecular surface (generally measured in angstroms, Å²) derived from polar atoms. Topological polar surface area is obtained by subtracting the area of carbon, halogen, and nonpolar hydrogen atoms (i.e., hydrogen atoms bonded to carbon atoms) from the molecular surface, thereby leaving the heteroatoms and polar hydrogen atoms.

Water solubility is impacted by the solvents water polarity. It is desirable for the solvents according to the description herein to have limited water polarity. Although the solvents are generally referred to as insoluble solvents some degree of water polarity is needed. The limited water polarity is determined based on total polar surface area with oxygen atoms (i.e., polar functional groups) to give some polarity, as described as the topological polar surface area above. The insoluble solvents with best performance have distinct chemical structures and classifications while providing the Log P≥1.75 and the Topological Polar Surface Area (Å²) that is about 50 or less, including 0. The need for some polar functional groups is demonstrated in the Examples by solvents with no polar functional groups having no efficacy.

In preferred embodiments, the insoluble solvents with best cleaning performance have a Log P≥1.75 and a Topological Polar Surface Area (Å²) that is about 50 or less, or preferably from about 0 to 50.

In a preferred embodiment the insoluble solvent is one or more of 2-ethylhexyl L-lactate, tripropylene glycol butyl ether, hexanol, 2-2(2-ethylhexyloxy)ethanol, octanoic acid, and Distillates (petroleum), hydrotreated light. Such insoluble solvents are commercially available. Commercially available insoluble solvents include, Purasolv EHL, a 2-Ethylhexyl L-Lactate and Purasolv EL, an Ethyl Lactate both available from Corbion, 2-2(2-ethylhexyloxy)ethanol (CAS 1559-35-9) which is also referred to as Ethylene Glycol 2-Ethylhexyl Ether, and Isopar M (CAS 64742-47-8) and other petroleum distillates.

In a more preferred embodiment the insoluble solvent is 2-2(2-ethylhexyloxy)ethanol that is beneficially stable in alkaline conditions.

In some embodiments, the insoluble solvent is included in the concentrate detergent and cleaning composition at an amount of at least about 10 wt-% to about 80 wt-%, 15 wt-% to about 80 wt-%, 20 wt-% to about 80 wt-%, about 35 wt-% to about 80 wt-%, about 35 wt-% to about 75 wt-%, or about 35 wt-% to about 70 wt-%. In addition, without being limited according to the disclosure, all ranges recited are inclusive of the numbers defining the range and include each integer within the defined range.

In embodiments the detergent and cleaning compositions can include insoluble solvents that can be emulsified in water when diluted. Beneficially the non-polar solvents are diluted with water to create a diluted solution that is used to clean various surfaces providing a benefit over conventional non-polar solvents at 100% concentration which is the conventional formulation for detergents and cleaning compositions. For example, the detergent and cleaning compositions are formulated as concentrated formulas that are diluted to low concentrations in water (i.e. 1% or even lower in embodiments). In most embodiments the use solution concentrations of the compositions will be provided at about 1-10% use solutions which can vary depending upon factors such as soils to be cleaned, etc.

### Surfactants

The detergent and cleaning compositions include surfactant(s) in combination with the insoluble solvent. In embodiments the surfactant(s) comprise an alkyl polyglucoside (APG) and/or amphoteric surfactant(s). Beneficially, the surfactants allow the insoluble solvent to be emulsified in water when diluted.

In embodiments, the surfactant(s) is/are included in the detergent and cleaning composition at an amount of at least about 1 wt-% to about 80 wt-%, about 1 wt-% to about 70 wt-%, about 1 wt-% to about 60 wt-%, about 1 wt-% to about 50 wt-%, or about 10 wt-% to about 50 wt-%. In addition, without being limited according to the disclosure, all ranges recited are inclusive of the numbers defining the range and include each integer within the defined range.

### Alkyl Polyglycosides (APG)

The detergent and cleaning compositions include one or more alkyl polyglycoside surfactants in combination with the insoluble solvent. Alkyl polyglycosides are characterized by one or more monosaccharide units and at least one hydrophobic alkyl group to one of the hydroxyl groups of the saccharide units. These molecules differ in the saccharide unit, the degree of polymerization (DP) of the saccharide units, the number of alkyl groups, the alkyl chain length, both linear and mono-branched, etc. Preferred APGs include alkyl polyglucosides, which are characterized by the saccharide moiety being glucose.

A class of alkyl polyglycosides has been widely used as nonionic surfactants in a variety of cosmetic, household, and industrial applications. The alkyl polyglycosides, which can be used in the present invention, are fatty ether derivatives of saccharides or polysaccharides which are formed when a carbohydrate is reacted under acidic condition and elevated temperatures with a fatty alcohol through condensation polymerization. Alkyl polyglycoside surfactants are usually characterized by one or more saccharide units, which are hydrophilic, in one end and a hydrophobic alkyl group in another end. They are usually derived from polysaccharides from natural resources and the raw materials are typically starch and fat. The final products can be a complex mixture of compounds with different sugar moieties comprising one or more hydrophilic alkyl groups from the fatty alcohol.

In embodiments, the APG preferably comprises the saccharide or polysaccharide groups (i.e., mono-, di-, tri-, etc. saccharides) of hexose or pentose, and a fatty aliphatic group with 6 to 20 carbon atoms. Alkyl polyglycosides which can be used in the present invention are represented by the general formula of (G)_{x-O—R}, where G is a moiety derived from a reducing saccharide containing 5 or 6 carbon atoms, e.g., pentose or hexose; R is fatty aliphatic group containing 6 to 20 carbon atoms; and x is the degree of polymerization (D.P.) of the polyglycoside, representing the number of monosaccharide repeating units in the polyglycoside. Generally, x is an integer on the basis of individual molecules, but because there are statistical variations in the manufacturing process of APGs, x may be a non-integer on an average basis.

In an embodiment, the APG employed in a detergent and cleaning composition has x preferably with a value of less than about 5, and more preferably between about 0.5 and about 5. Even more preferably, x is less than about 2.5, and more preferably is within the range between about 1 and about 2.

Commercially available alkyl polyglycosides may contain a blend of carbon lengths. Suitable alkyl polyglycosides include alkyl polyglycosides containing short chain carbons, such as chain lengths of less than C₁₆. In one example, suitable alkyl polyglycosides include C₅-C₁₆ alkyl polyglycosides. Additional description of suitable alkyl polyglycosides are set forth, for example, in U.S. Pat. Nos. 8,697,622, 8,658,584, 8,557,760, 8,389,457, 8,287,659 and 8,299,009, and U.S. Patent Publication Nos. 2013/0023458 and 2012/0322710, which are herein incorporated by reference in their entirety.

Exemplary saccharides from which G is derived are glucose, fructose, mannose, galactose, talose, gulose, allose, altrose, idose, arabinose, xylose, lyxose and ribose. Because of the ready availability of glucose, glucose is preferred in the making of polyglycosides. The fatty aliphatic group, which is the substituent of the preferred polyglycoside, is preferably saturated, although unsaturated fatty group may be used.

Preferably the APGs have an average degree of polymerization of saccharides from 1.4 to 1.7 and the chain lengths of the aliphatic groups are between C8 to C16. Commercially, alkyl polyglycosides can be provided as concentrated, aqueous solutions ranging from 50 to 70 wt. % active. Examples of commercial suppliers of alkyl polyglycosides are Dow, BASF, Seppic, Akzo Nobel, and Croda.

Alkyl polyglycoside can act as an emulsifier. Emulsifiers are amphipathic surface active compounds which possess both hydrophilic and hydrophobic moieties. The ratio of hydrophilic and hydrophobic moieties in a compound is commonly expressed as the hydrophilic-lipophilic balance, or HLB. Low HLB ranges (i.e., 3-6) tend to indicate water-in-oil emulsions, whereas higher HLB ranges (i.e., 8-18) tend to indicate oil-in-water emulsions.

In a preferred embodiment, the alkyl polyglycoside has an HLB of at least about 8, at least about 9, or at least about 10. In further aspects, the alkyl polyglycoside has an HLB of from about 8 to about 18, from about 9 to about 18, or from about 10 to about 18. An exemplary natural fatty alcohol-based alkyl polyglycoside is C10-C16 alkyl polyglycoside commercially available as Glucopon® 600UP (BASF Company).

In embodiments the compositions include a combination of two or more alkyl polyglycosides, such as a low HLB alkyl polyglycoside surfactant (e.g. HLB<10) and a high HLB alkyl polyglycoside surfactant (e.g. HLB>10). For example, in an embodiment the compositions can include two or more alkyl polyglycosides comprising sorbitan monolaurate (HLB of 9) and/or sorbitan monooleate (HLB of 4) in combination with a high HLB surfactant (i.e. C8-C10 APG with an HLB of 14 and/or C7 APG with an HLB of 14).

In embodiments, the APG surfactant(s) is/are included in the detergent and cleaning composition at an amount of at least about 1 wt-% to about 30 wt-%, about 5 wt-% to about 30 wt-%, about 5 wt-% to about 25 wt-%, or about 5 wt-% to about 20 wt-%. In addition, without being limited according to the disclosure, all ranges recited are inclusive of the numbers defining the range and include each integer within the defined range.

### Amphoteric Surfactants

The detergent and cleaning compositions in many embodiments include an amphoteric co-surfactant in combination with the insoluble solvent to beneficially provide solubility of the APG with the insoluble solvent. It is unexpected to find the amphoteric surfactants provide not only improved performance while also formulating an emulsion of the APG and insoluble solvent. In other embodiments a co-solvent such as an alcohol may replace amphoteric co-surfactant.

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present invention generally have the general formula:

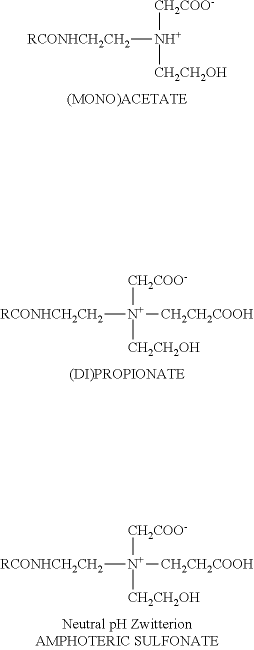

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein. The amphoteric surfactant suitable for use in the present compositions includes a betaine of the general structure:

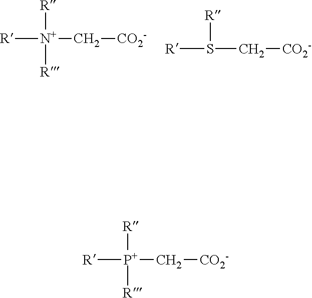

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include cocoamidopropyl betaines, such as coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Long chain N-alkylamine acids, or iminodipropionates, are readily prepared by reaction RNH₂, in which R=C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H4COOM)₂ and RNHC₂H4COOM. In an embodiment, R can be an acyclic hydrophobic group containing from about 8 to about 18 carbon atoms, and M is a cation to neutralize the charge of the anion. Preferred iminodipropionates include sodium octyliminodipropionate or alkyl iminodipropionic acid. Exemplary iminodipropionates are commercially available as Tomamine® Amphoteric 12 (Evonik Industries) and Tomamine® Amphoteric 400 (Evonik Industries).

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N+(CH₂—CH₂—CO₂Na)₂—CH₂—CH₂—OH or C₁₂-alkyl-C(O)—N(H)—CH₂—CH₂—N+(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

Further examples are given in “Surface Active Agents and Detergents” (Vol. I and II by Schwartz, Perry and Berch), which is herein incorporated by reference in its entirety.

In some embodiments, the composition or detergent composition disclosed herein is free of an amphoteric surfactant.

In embodiments, the amphoteric surfactant(s) is/are included in the detergent and cleaning composition at an amount of at least about 1 wt-% to about 40 wt-%, about 5 wt-% to about 40 wt-%, about 10 wt-% to about 40 wt-%, or about 10 wt-% to about 35 wt-%. In addition, without being limited according to the disclosure, all ranges recited are inclusive of the numbers defining the range and include each integer within the defined range.

### Chelants

The detergent and cleaning compositions can optionally include a chelant. Chelants include, but are not limited to, chelating agents (chelators), sequestering agents (sequestrants), detergent builders, and the like. Examples of chelants include, but are not limited to, phosphonates, phosphates, aminocarboxylates and their derivatives, pyrophosphates, polyphosphates, ethylenediamine and ethylenetriamine derivatives, hydroxyacids, and mono-, di-, and tri-carboxylates and their corresponding acids. Other exemplary chelants include aluminosilicates, nitroloacetates and their derivatives, and mixtures thereof.

Suitable aminocarboxylic acids according to the invention include, but are not limited to, methylglycinediacetic acid (MGDA), glutamic acid-N,N-diacetic acid (GLDA), N-hydroxyethylaminodiacetic acid, ethylenediaminetetraacetic acid (EDTA) (including tetra sodium EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), ethylenediaminesuccinic acid (EDDS), 2-hydroxyethyliminodiacetic acid (HEIDA), iminodisuccinic acid (IDS), 3-hydroxy-2-2′-iminodisuccinic acid (HIDS) and other similar acids or salts thereof having an amino group with a carboxylic acid substituent. Additional description of suitable aminocarboxylates suitable for use as chelating agents and/or sequestrants is set forth in Kirk-Othmer, Encyclopedia of Chemical Technology, Third Edition, volume 5, pages 339-366 and volume 23, pages 319-320, the disclosure of which is incorporated by reference herein.

Chelants can be water soluble, and/or biodegradable. Other exemplary chelants include TKPP (tetrapotassium pyrophosphate), PAA (polyacrylic acid) and its salts, phosphonobutane carboxylic acid, Alanine, N,N-bis(carboxymethyl)-, trisodium salt, and sodium gluconate.

In some embodiments, the chelant is free of phosphorus. Preferably, the chelant is a sodium salt of aminocarboxylates. More preferably, the chelant is methyl glycine diacetic acid (MGDA).

In some embodiments, the composition disclosed herein is free of a chelant.

In embodiments, the chelant is/are included in the detergent and cleaning composition at an amount of at least about 0 wt-% to about 30 wt-%, about 0 wt-% to about 25 wt-%, about 0 wt-% to about 20 wt-%, about 1 wt-% to about 20 wt-%, or about 1 wt-% to about 10 wt-%. In addition, without being limited according to the disclosure, all ranges recited are inclusive of the numbers defining the range and include each integer within the defined range.

### Additional Functional Ingredients

The components of the detergent and cleaning compositions can further be combined with various functional components suitable for uses disclosed herein. In some embodiments, the compositions including the insoluble solvent, surfactants and optionally the chelant make up a large amount, or even substantially all of the total weight of the detergent and cleaning compositions. For example, in some embodiments few or no additional functional ingredients are disposed therein.

In other embodiments, additional functional ingredients may be included in the detergent and cleaning compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the detergent compositions may include optical brighteners, defoaming agents, anti-redeposition agents, bleaching agents, solubility modifiers, dispersants, metal protecting agents, soil antiredeposition agents, stabilizing agents, corrosion inhibitors, builders/sequestrants/chelating agents, enzymes, aesthetic enhancing agents including fragrances and/or dyes, additional rheology and/or solubility modifiers, diluents or thickeners, hydrotropes or couplers, buffers, solvents, additional cleaning agents and the like.

In an embodiment an additional cleaning agent can include a basic alkaline cleaning agent, e.g. alkali metal hydroxide. However, in preferred embodiments alkaline components such as an alkaline cleaning agent would be combined at a point of use as a separate booster in a 2-part system to maintain an effectively neutral pH of the composition.

In an embodiment additional diluents can be included, e.g. propylene glycol and/or glycerin.

According to embodiments of the disclosure, the various additional functional ingredients may be provided in a composition in the amount between about 0 wt-% and about 50 wt-%, from about 0.01 wt-% and about 50 wt-%, from about 0.1 wt-% and about 50 wt-%, from about 1 wt-% and about 50 wt-%, from about 1 wt-% and about 30 wt-%, from about 1 wt-% and about 25 wt-%, or from about 1 wt-% and about 20 wt-%. In addition, without being limited according to the disclosure, all ranges recited are inclusive of the numbers defining the range and include each integer within the defined range.

In an embodiment the detergent and cleaning compositions are free of anionic surfactants and/or ethoxylated nonionic surfactants. In a further embodiment the detergent and cleaning compositions are free of abrasive material, including those comprising polystyrene particles, such as disclosed in U.S. Pat. No. 7,393,820.

### Methods of Use

The methods of cleaning are particularly well suited for removing hydrophobic and/or oily soils, such as cosmetic soils. As referred to herein, cosmetic soils include for example, lipsticks, lip gloss, mascaras, sunscreens, clay masks, deodorants, hair treatment compositions, and the like. Without being limited to a theory or mechanism of action, it is believed that the hydrophobic portion of the various cosmetic soils make the soils particularly difficult to remove from surfaces. For example, hydrophobic portions of cosmetic soils (e.g., lipsticks) can be in the form of an oil, a viscous solid, silicones, or a wax, depending on the desired consistency of the cosmetic product. For example, a lip gloss that is rolled onto the lips will tend to be more liquid in consistency than a lip gloss that is applied using a fingertip. Naturally, one would expect the roll-on lip gloss to have a higher oil content than a fingertip lip gloss, which would have more solids or waxes. Such hydrophobic components of cosmetic soils may be natural and/or synthetic, including for example, waxes, canola oil, cetyl alcohol, cetyl esters, cocoa (Theobroma cacao) butter, coconut (Cocos nucifera) oil, hydrolyzed beeswax, lanolin oil, lanolin wax, mineral oil, paraffin, PEG beeswax, petrolatum, petroleum jelly, shea butter, and many others. Additional materials found in cosmetics include, for example, silicones, such as dimethicone, other silicone based materials, such as Amodimethicone, along with other pigments, dyes, colorants and fragrances. Cosmetics products may also contain various forms of sunscreen agents, for example titanium oxide and zinc oxide, both of them frequently leaving undesirable white films behind after soil removal.

It is understood that the detergent and cleaning compositions disclosed herein are capable of removing such exemplary soils, including cosmetic soils having the hydrophobic and other materials described above as well as those not included in the list above. In an embodiment, the hydrophobic soil is an oil, a viscous solid, silicone, wax, pigment, or combination thereof.

The methods of cleaning include contacting a surface in need of removing such soils. In an aspect, the surface is a hard surface that is soiled with a waxy, oily and/or greasy cosmetic soil. Any means of contacting can be used to place the surface in contact with the detergent and cleaning compositions, including for example, soaking, spraying, dripping, wiping, or the like. Included within the scope of contacting described herein, the surface can also be soaked, including a pretreatment, with the detergent and cleaning compositions (or individual portions thereof). As a result of the contacting step the surface is cleaned, and the soils removed.

In certain embodiments a concentrate can be sprayed onto a surface for a hard surface treatment. The contacting time may vary from a few seconds to a few minutes. In other embodiments, a lower concentration of the detergent and cleaning compositions may be employed for a presoak application, such as where a surface is soaked before further cleaning (e.g., mechanical action and/or force applied in a cleaning application). In such embodiments the contact time can vary from a few minutes to a few hours (e.g., overnight soak).

In an aspect, the surface is a hard surface. In a further aspect, the surface is a hard surface having one or more hydrophobic and/or oily soils, such as cosmetic soils. Exemplary surfaces include cosmetic manufacturing equipment such as those found in industrial applications. One skilled in the art will ascertain that such hard surfaces can be metal (e.g., stainless steel, aluminum), concrete, glass, ceramic, and/or plastic surfaces. Due to the neutral pH of the detergent and cleaning compositions, the compositions described herein are beneficially soft metal safe.

In another aspect, the surface is a soft surface. In a further aspect, the surface is a soft surface having one or more hydrophobic and/or oily soils, such as cosmetic soils. Exemplary soft surfaces include ware and/or linens such as towels, sheets, and nonwoven webs. In an embodiment the cleaning steps are suitable for use in laundry applications adapted for maintaining the insoluble solvent in an emulsion and does not separate from the water in particular under elevated temperatures. In an exemplary laundry method ensuring the insoluble solvent does not separate from the water may include mixing or agitation, such as in conventional in machine laundering processes.

The cleaning steps described herein can constitute part of a manual wash process with mixing or agitation to ensure the insoluble solvent does not separate from the water. In an alternative aspect, the ware is washed in an automated fashion and/or involving mechanical force or action applied in combination or after the detergent and cleaning compositions is contacted to the surface. An example of mechanical action and/or force can include, for example, application using spray nozzles, movement within a mixing tank, or manual and/or mechanical scrubbing. In some embodiments agitation is employed to assist in removing the soils. However, in other applications no agitation, whether mechanical action or otherwise is required to remove the soils providing a significant benefit over state of the art cleaning methods. Due to the neutral pH of the detergent and cleaning compositions, the compositions described herein are beneficially low foaming and are safer than commercially available detergents.

In washing applications, soaking (or pretreatment) applications and/or other hard surface treatment applications, the detergent and cleaning compositions can be applied to the surface alone, or in combination with additional builder composition and/or additional booster compositions (i.e., cleaning systems). In some embodiments, the detergent and cleaning compositions can be employed in a soaking application alone, such that no mechanical action and/or force is required to remove the soils. Instead, soaking with the aqueous wash solution followed by rinsing is adequate to remove soils according to the methods described herein.

The detergent and cleaning compositions can be applied in a concentrate and/or use solution. In embodiments, where a concentrate composition is applied, a first step of diluting and/or creating an aqueous use solution can also be included in the methods. An exemplary dilution step includes contacting the liquid composition with water.

The detergent and cleaning compositions can be provided at an actives level in a ready to use and/or concentrate composition providing a desired amount of actives of the components of the compositions, namely the surfactants of the detergent composition. In an aspect, a suitable concentration of the detergent and cleaning compositions is applied to a surface at a concentration from about 0.5% to about 20% in a use solution, from about 1% to about 10% in a use solution, or from about 1% to about 6% in a use solution.

In an aspect, the detergent and cleaning composition is applied to a surface. In embodiments where the detergent and cleaning composition is applied to a surface in need of cleaning, a use solution will have a pH of between about 6 to about 9, or preferably about 6.5 to about 7.5.

In an aspect, the detergent and cleaning composition contacts the surface at any suitable temperature. In an aspect, the temperature is between about ambient (generally 50°-60° F.) to about 200° F., between about 20° F. and about 180° F., between about 30° F. and about 160° F., between about 40° F. and about 140° F., between about 50° F. and about 120° F., between about 60° F. and about 100° F., between about 70° F. and about 90° F., or between about 70° F. and about 80° F. Beneficially according to embodiments of use the detergent and cleaning compositions are low foaming, even at low temperatures allowing use at a broad range of temperatures. This is distinct from conventional detergents that are only low foaming at high temperatures, but then have much higher foam levels at low temperatures.

In an aspect, the detergent and cleaning composition contacts the surface for a sufficient amount of time to remove the soils, including from a few seconds to a few hours, including all ranges therebetween. In an embodiment, the detergent and cleaning composition contacts the surface for at least about 15 seconds, at least about 30 seconds, at least about 45 seconds, or at least about 60 seconds. In additional embodiments, the detergent and cleaning composition contacts the surface for at least about 1 minute, at least about 2 minutes, at least about 3 minutes, at least about 4 minutes, or at least about 5 minutes. In still other embodiments the detergent and cleaning composition contacts the surface for at least about 15 minutes, at least about 30 minutes, at least about 60 minutes, at least about 2 hours, or longer.

In an aspect, the detergent and cleaning composition can further include or exclude the use of mechanical force to aid in removal of the soils.

### EMBODIMENTS

The present disclosure is further defined by the following numbered embodiments:

1. A detergent and cleaning composition comprising: an insoluble solvent; and at least one alkyl polyglycoside surfactant and optionally a co-surfactant or co-solvent to provide an emulsion.

2. The composition of embodiment 1, wherein the insoluble solvent comprises at least one polar functional group.

3. The composition of any one of embodiments 1-2, wherein the insoluble solvent has a Log P≥1.75.

4. The composition of any one of embodiments 1-3, wherein the insoluble solvent has a Topological Polar Surface Area (Å²) of about 50 or less.

5. The composition of any one of embodiments 1-4, wherein the insoluble solvent is one or more of 2-ethylhexyl L-lactate, tripropylene glycol butyl ether, hexanol, 2-2(2-ethylhexyloxy)ethanol, octanoic acid, and petroleum distillate, and preferably is 2-2(2-ethylhexyloxy)ethanol.

6. The composition of any one of embodiments 1-5, wherein the alkyl polyglycoside surfactant has an HLB of about 8 to about 18, or a first alkyl polyglycoside surfactant with an HLB>10 and a second alkyl polyglycoside surfactant with an HLB<10.

7. The composition of embodiment 6, wherein the alkyl polyglycoside surfactant is a C8-C16 alkyl polyglycoside, or a combination of the first alkyl polyglycoside surfactant with an HLB between about 4-9 and the second alkyl polyglycoside surfactant with an HLB of about 14.

8. The composition of any one of embodiments 1-7, wherein the co-surfactant comprises an amphoteric surfactant and/or wherein the co-solvent comprises an alcohol.

9. The composition of any one of embodiments 1-8, wherein the co-surfactant comprises a betaine.

10. The composition of any one of embodiments 1-9, wherein the composition has a neutral pH between about 6 to about 9.

11. The composition of any one of embodiments 1-10, further comprising a chelant, diluent and/or basic alkaline cleaning agent.

12. The composition of any one of embodiments 1-11, wherein the insoluble solvent from about 10 wt-% to about 80 wt-% of the total composition, wherein the alkyl polyglucoside surfactant comprises from about 1 wt-% to about 80 wt-% of the total composition, wherein the co-surfactant and/or co-solvent comprises from about 0 wt-% to about 80 wt-% of the total composition, and wherein the chelant comprises from about 0 wt-% to about 30 wt-% of the total composition.

13. The composition of any one of embodiments 1-12, wherein a use solution of the composition comprises the composition at a concentration of about 0.5 wt-% to about 20 wt-%, or preferably from about 1 wt-% to about 10 wt-%.

14. A method of use comprising: applying the composition of any one of embodiments 1-13 to a surface in need of soil removal, wherein the soil is hydrophobic and/or oily soil; and removing the soil.

15. The method of embodiment 14, wherein the surface is a hard surface or a soft surface.

16. The method of any one of embodiments 14-15, wherein the composition is applied for at least about 15 seconds.

17. The method of any one of embodiments 14-16, wherein the hydrophobic and/or oily soil is a cosmetic soil, and/or wherein the hydrophobic and/or oily soil comprises silicone.

18. The method of any one of embodiments 14-17, wherein the hydrophobic soil is an oil, a viscous solid, silicone, wax, pigment, or combination thereof.

19. The method of any one of embodiments 14-18, wherein the composition is applied to the surface at a temperature of between about 50° F. and about 200° F.

20. The method of any one of embodiments 14-19, wherein the composition shows an improved soil removal in comparison to detergent and/or cleaning compositions free of the insoluble solvent.

21. The method of any one of embodiments 14-20, further comprising adding a basic alkaline cleaning agent with the composition to remove the soil.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following materials were utilized in the Examples to evaluate various insoluble solvent and surfactant systems for cleaning hydrophobic soils, including various shower and hair care, oral care, deodorant, face and body care, lip gloss, lipstick, mascara, foundation, and sun protection types of soils.
Purasolv EHL—a 2-Ethylhexyl L-Lactate insoluble solvent commercially available from Corbion.
Glucopon 600 UP—a Lauryl/Myristyl Glucoside surfactant commercially available from BASF.
Tomamine Amphoteric 400—a Sodium Octyliminodipropionate surfactant commercially available from Evonik.
Tomamine Amphoteric 12—an Alkyl Iminodipropionic acid, monosodium salt surfactant commercially available from Evonik.
Trilon M, Liquid Neut.—an Trisodium Methylglycinediacetic Acid (MGDA) commercially available from BASF.
Purasolv EL—an Ethyl Lactate co-solvent commercially available from Corbion.

### Example 1

A soiled coupon cleaning method was conducted to assess soil removal efficacy of various solvents in the detergent and cleaning compositions described herein against lipstick soils on stainless steel coupons (SS318, 2×3 inch coupons, vertical grain). The soil—Maybelline Lipstick. were spread evenly on a coupon with a foam brush or applied with an application device provided with the product. The coupons were dried overnight at room temperature. The soiled coupons were weighed on an analytical balance the following day and the data recorded. The soiled coupons were then placed in an agitated beaker for cleaning using the various combinations of the detergent composition and/or builder composition.

The soiled coupons were soaked under agitation for 30 minutes at 140° F. (60° C.) with approximately 4% concentration of the various detergent and cleaning compositions described in Table 2 according to the solvent in the formulation.

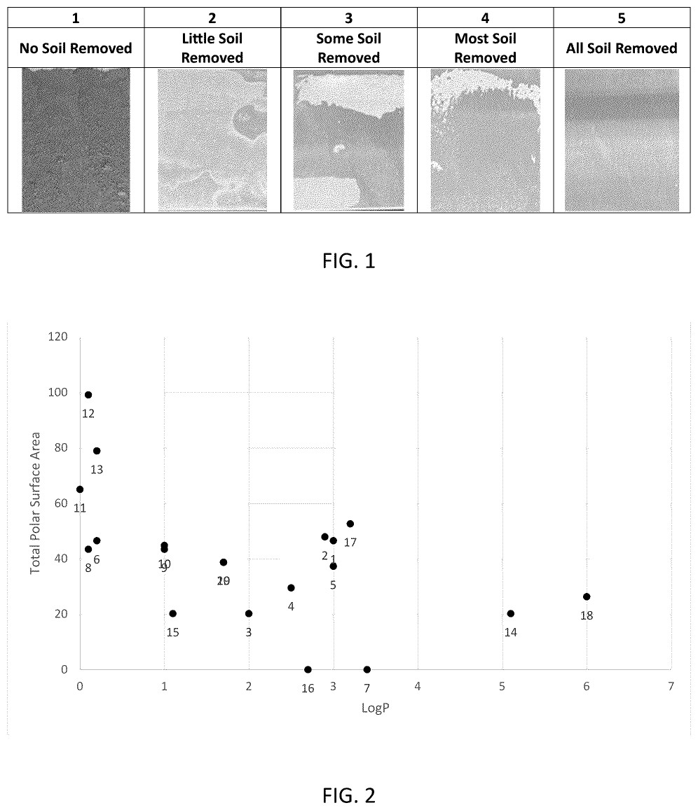

The soiled coupons were visually observed every 5 minutes for visual assessment of soil removal and given a visual rating of 1-5 (1=no soil removal, 5==complete soil removal). An exemplary visual score is shown in FIG. 1. All observations of the soiled coupons were averaged to give a normalized result for cleaning performance. The resulting visual rates of the evaluated composition solutions comprising the different solvents on the lipstick soil are shown in Table 2.

TABLE 2

| | | | Topological | |
|---|---|---|---|---|
| | | | Polar | |
| | | | Surface | Visual |
| Solvent | Rank | LogP | Area (Å²) | Result |
| 2-Ethylhexyl Lactate | 1 | 3 | 46.5 | 3.29 |
| Tripropylene glycol butyl ether | 2 | 2.9 | 47.9 | 3 |
| Hexanol | 3 | 2 | 20.2 | 2.14 |
| 2-2(2-Ethylhexyloxy)ethanol | 4 | 2.5 | 29.5 | 1.71 |
| Octanoic acid | 5 | 3 | 37.3 | 1.29 |
| Ethyl Lactate | 6 | 0.2 | 46.5 | 1 |
| Limonene | 7 | 3.4 | 0 | 1 |
| NXTSOLV 100 | 8 | 0.1 | 43.4 | 1 |
| NXTSOLV 200 | 9 | 1 | 43.4 | 1 |
| NXTSOLV 300 | 10 | 1 | 44.8 | 1 |
| NXTSOLV 400 | 11 | 0 | 65 | 1 |
| Triethyl Citrate | 12 | 0.1 | 99.1 | 1 |
| Glycerol Triacetate | 13 | 0.2 | 78.9 | 1 |
| Dodecanol (Lauryl Alcohol) | 14 | 5.1 | 20.2 | 1 |
| Benzyl Alcohol | 15 | 1.1 | 20.2 | 1 |
| Toluene | 16 | 2.7 | 0 | 1 |
| Diisobutyl Adipate | 17 | 3.2 | 52.6 | 1 |
| FAME | 18 | 6 | 26.3 | 1 |
| Propylene glycol phenyl ether | 19 | 1.7 | 38.7 | 1 |
| Diethylene glycol monohexyl ether | 20 | 1.7 | 38.7 | 1 |

Similarly, FIG. 2 shows the Log P and Topological Polar Surface Area Values of the solvents which correspond to the found visual rankings of Table 2. The Log P and Topological Polar Surface Area Values were obtained from PubChem.

These results in FIG. 2 show the best soil removal results with >1 visual rating score have a Log P≥2 and a Topological Polar Surface Area (Å²) between about 20-50. The results show that the solvents although generally referred to as insoluble solvents are water insoluble with some water polarity. The limited water polarity is determined based on total polar surface area with oxygen atoms (i.e. polar functional groups) to give some polarity. The insoluble solvents with best performance have distinct chemical structures and classifications while providing the Log P≥1.75 and the Topological Polar Surface Area (Å²) between about 15-50. The impact of limited water polarity is further demonstrated by no efficacy achieved by solvents that are only carbon (i.e. toluene) as they have no polar functional groups.

### Example 2

The soiled coupon cleaning method of Example 1 was conducted to assess soil removal efficacy of the experimental detergent compositions described herein and 3 commercially available detergent compositions against 12 different cosmetic soils on stainless steel coupons. The soils—shower and hair care, oral care, deodorant, face and body care, lip gloss, lipstick, mascara, foundation, and sun protection—were each spread evenly on a coupon with a foam brush. The coupons were dried overnight and were placed in an agitated beaker for cleaning using the various combinations of the detergent composition and/or builder composition.

A 400 mL beaker contained 300 mL of cleaning solutions (total dosage of 4% concentrate on) heated to 140° F. and stirred at 250 rpm. The soiled coupons were soaked under agitation for 30 minutes. The coupons were again weighed after cleaning to determine percent soil loss by weight and the cleaning efficiency was calculated based on the percentage of weight-based soil removed. The evaluated detergent and cleaning composition was formulated according to Table 3 below. The evaluated commercially available detergent compositions are summarized in Tables 4-6 with descriptions from Safety Data Sheets, notably the compositions do not include insoluble solvents as described herein.

TABLE 3
Formulation A diluted to a concentration of 1-6%

| Chemical Name | Wt. % |
|---|---|
| Insoluble Solvent | 50-60 |
| Surfactant - Alkyl Polyglucoside | 15-20 |
| Surfactant | |
| Chelant | 2-10 |
| Amphoteric Surfactant | 20-25 |
| Total | 100 |

TABLE 4
Commercial Detergent Composition #1

| Chemical Name | Wt. % |
|---|---|
| Nonionic surfactants | 5-15 |
| Neutralized Octanoic Acid, Sodium Salt | 5-10 |
| Alkalinity | 2-10 |
| Additional components | Remainder |
| Total | 100 |

TABLE 5
Commercially Available Detergent Composition #2

| Chemical Name | Wt. % |
|---|---|
| Alkalinity sources | 25-35 |
| Nonionic surfactant | 10-20 |
| Amine oxide | 5-10 |
| Additional components | Remainder |
| Total | 100 |

TABLE 6
Commercially Available Detergent Composition #3

| Chemical Name | Wt. % |
|---|---|
| Tetrasodium (1- | 10-20 |
| hydroxyethylidene)biphosphonate | |
| Nonionic surfactant | 10-20 |
| Amine oxide | 5-10 |
| Alkalinity | 1-2 |
| Additional components | Remainder |
| Total | 100 |

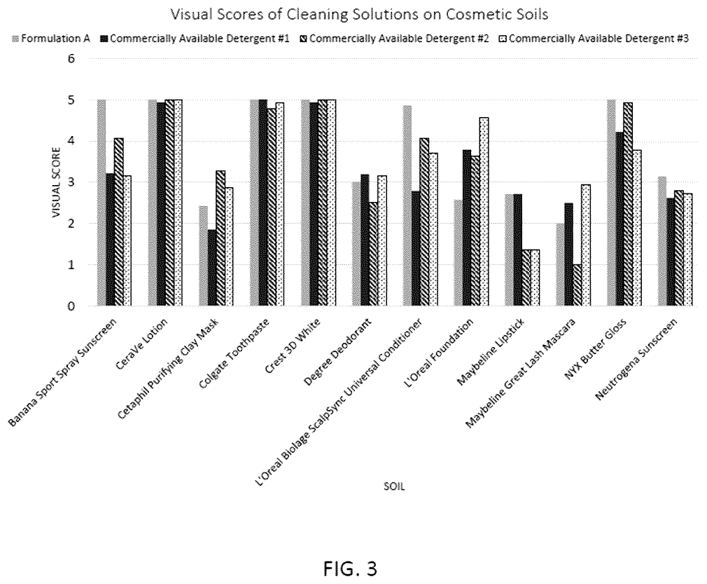

The soiled coupons were visually observed every 5 minutes for visual assessment of soil removal and given a visual rating of 1-5 (1=no soil removal, 5=complete soil removal). The resulting visual rates of the cleaning solutions on the 12 cosmetic soils are shown in FIG. 3. The average rating of the evaluated composition of Formulation A was 3.81 over all cosmetic soils demonstrating enhanced soil removal compared to commercial control detergents compositions as summarized in Table 7.

TABLE 7
Average Rating on all Soils

| | Commercially | Commercially | Commercially |
|---|---|---|---|
| | Available | Available | Available |
| | Detergent | Detergent | Detergent |
| Formulation A | #1 | #2 | #3 |
| 3.81 | 3.48 | 3.54 | 3.60 |

As can be seen in FIG. 3 and Table 7, Formulation A shows an improved efficacy in removing traditionally insolvent soils over the commercially available detergents as a result of the insoluble solvent aiding in the removal of these soils. Without being limited to a particular mechanism of action the insoluble solvents aid in dissolving soils, namely the oily and hydrophobic portions, in addition to emulsification, soil suspension, chelation, etc. cleaning mechanisms associated with traditional aqueous based detergents.

### Example 3

The methods of cleaning soiled coupons of Examples 1-2 were utilized to assess soil removal efficacy of the experimental detergent compositions described herein and various combinations of 7 commercially available detergents against lipstick soil on stainless steel coupons. The lipstick soil was an experimental formulation known to be difficult to clean. The lipstick was spread evenly on coupons and dried overnight before being soaked in the cleaning solutions. The concentration of the evaluated detergent and cleaning compositions were evaluated alone and with surfactants at both 2% and 5% of the total composition (use solution applied) as listed in Tables 3-6 for 10 minutes, 30 minutes, and 60 minutes at 140° F., 160° F., and 180° F., the results of which are shown in Table 8. Commercial products 1-3 are the same commercially available detergents as described in Example 2, Tables 4-6. Commercial product 4 is a liquid oxygen (oxidizing) cleaning additive used with alkaline and acid clean-in-place detergents comprising hydrogen peroxide, C12-C18 alcohols, and polyethylene glycol. Commercial product 5 is a neutral cleaning additive used with alkaline and acid clean-in-place detergents for organic soils, such as fats comprising alkylamine ethoxylates, C12-C18 alcohols, and polyethylene glycol. Commercial product 6 is an acidic detergent cleaner comprising nitric acid and phosphoric acid. Commercial product 7 is an alkaline detergent cleaner comprising sodium hydroxide. The commercial products do not contain the insoluble solvents as described herein and included in Formula A.

TABLE 8

| Coupon | | Concen- | | Temper- | |
|---|---|---|---|---|---|
| # | Product | tration | Time | ature | Results |
| 1 | Commercial | 5% | 30 | 160 | Layer of |
| | Product 1 | | | | soil remains |
| 2 | Commercial | 5% | 30 | 160 | Layer of |
| | Product 1 | | | | soil remains |
| | Commercial | 2% | | | |
| | Product 4 | | | | |
| 3 | Commercial | 5% | 60 | 160 | Layer of |
| | Product 1 | | | | soil remains |
| | Commercial | 1% | | | |
| | Product 5 | | | | |
| 4 | Commercial | 2% | 10 | 160 | Layer of |
| | Product 1 | | | | soil remains, |
| | Commercial | 5% | 30 | | yet seemed |
| | Product 1 | | | | to clean the |
| | Commercial | 2% | | | best pre- |
| | Product 4 | | | | rinse |
| 5 | Commercial | 2% | 10 | 160 | Layer of |
| | Product 4 | | | | soil remains |
| | Commercial | 5% | 30 | | |
| | Product 1 | | | | |
| | Commercial | 2% | | | |
| | Product 4 | | | | |
| 6 | Commercial | 5% | 30 | 160 | Layer of |
| | Product 3 | | | | soil remains |
| 7 | Commercial | 5% | 30 | 160 | Layer of |
| | Product 3 | | | | soil remains |
| | Commercial | 2% | | | |
| | Product 4 | | | | |
| 8 | Commercial | 2% | 10 | 160 | Layer of |
| | Product 3 | | | | soil remains |
| | Commercial | 5% | 30 | | |
| | Product 3 | | | | |
| 9 | Commercial | 2% | 10 | 160 | Layer of |
| | Product 2 | | | | soil remains |
| | Commercial | 5% | 30 | | |
| | Product 2 | | | | |
| 10 | Commercial | 2% | 30 | 160 | Layer of |
| | Product 6 | | | | soil remains |
| 11 | Commercial | 2% | 30 | 160 | Layer of |
| | Product 7 | | | | soil remains |
| | Commercial | 2% | | | |
| | Product 5 | | | | |
| 12 | Commercial | 2% | 30 | 160 | Layer of |
| | Product 7 | | | | soil remains |
| | Commercial | 2% | | | |
| | Product 1 | | | | |
| 13 | Formula A | 10% | 60 | 140 | 2 soil spots |
| | | | | | and very faint |
| | | | | | soil marks |
| | | | | | remain |
| 14 | Formula A | 10% | 60 | 180 | Very faint |
| | | | | | soil marks |
| | | | | | remain where |
| | | | | | soil applied |

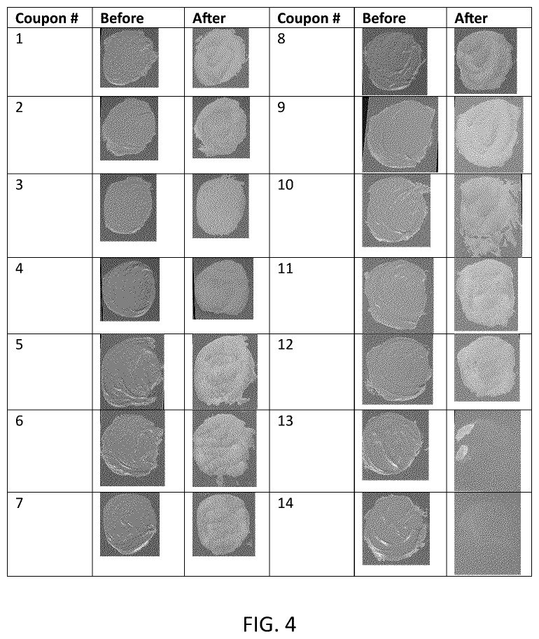

Visual results before and after cleaning are shown in FIG. 4 to illustrate the results summarized in Table 8. These results show that the Formula A according to the description herein outperforms the commercial products in soil removal based on the summary of observed soil removal results.

### Example 4

Commercial products were generally compared to the experimental formula A by cleaning efficacy, pH, safety, and other factors. The commercial products are the same commercial products #1-3 as in Examples 2 and 3, and additionally commercial product 8 is a commercially available alkaline detergent. The commercial products all were highly alkaline, pH of about 11-12, whereas the experimental formula A is about neutral with a pH of about 7. Due to the pH level of the experimental formula, it is soft metal safe, reduces costs by eliminating the need to adjust the pH during wastewater treatment, and has a lower safety risk. Additionally, the experimental formula is readily biodegradable and has an extremely low foam level, which reduces time and water consumption during rinsing after cleaning, especially for high foaming soils, such as shampoos, conditioners, toothpastes, etc., and could decrease the amount of defoamer needed during wastewater treatment. Thus, not only does the experimental formula have superior cleaning performance when compared to commercial products, it provides additional cost-saving and risk benefits over the commercial products.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A detergent and cleaning composition comprising:
an insoluble solvent;
at least one alkyl polyglycoside surfactant; and
at least one of a co-surfactant and/or co-solvent to provide an emulsion.

2. The composition of claim 1, wherein the insoluble solvent comprises at least one polar functional group.

3. The composition of claim 1, wherein the insoluble solvent has a Log P≥1.75.

4. The composition of claim 1, wherein the insoluble solvent has a Topological Polar Surface Area (Å²) of about 50 or less.

5. The composition of claim 1, wherein the insoluble solvent is one or more of 2-ethylhexyl L-lactate, tripropylene glycol butyl ether, hexanol, 2-2(2-ethylhexyloxy)ethanol, octanoic acid, and petroleum distillate.

6. The composition of claim 1, wherein the alkyl polyglycoside surfactant has an HLB of about 8 to about 18, or wherein a first alkyl polyglycoside surfactant has an HLB>10 and a second alkyl polyglycoside surfactant has an HLB<10.

7. The composition of claim 6, wherein the alkyl polyglycoside surfactant is a C8-C16 alkyl polyglycoside, or wherein there is a combination of the alkyl polyglycoside surfactants wherein the first alkyl polyglycoside surfactant has an HLB between about 4-9 and the second alkyl polyglycoside surfactant has an HLB of about 14.

8. The composition of claim 1, wherein the composition comprises both the co-surfactant and the co-solvent to provide an emulsion, and/or wherein the co-surfactant comprises an amphoteric surfactant, and/or wherein the co-solvent comprises an alcohol.

9. The composition of claim 1, wherein the co-surfactant comprises a betaine.

10. The composition of claim 1, wherein the composition has a neutral pH between about 6 to about 9.

11. The composition of claim 1, further comprising a chelant and/or diluent.

12. The composition of claim 1, wherein the insoluble solvent comprises from about 10 wt-% to about 80 wt-% of the total composition, wherein the alkyl polyglucoside surfactant comprises from about 1 wt-% to about 80 wt-% of the total composition, wherein the co-surfactant and/or co-solvent comprises from about 0 wt-% to about 80 wt-% of the total composition.

13. The composition of claim 1, wherein a use solution of the composition comprises the composition at a concentration of about 0.5 wt-% to about 20 wt-%.

14. A method of use comprising:
applying the composition of claim 1 to a surface in need of soil removal,
wherein the soil is hydrophobic and/or oily soil; and
removing the soil.

15. The method of claim 14, wherein the surface is a hard surface or a soft surface.

16. The method of claim 14, wherein the composition is applied for at least about 15 seconds.

17. The method of claim 14, wherein the hydrophobic and/or oily soil is a cosmetic soil, and/or wherein the hydrophobic and/or oily soil comprises silicone, and/or wherein the hydrophobic soil is an oil, a viscous solid, silicone, wax, pigment, or combination thereof.

18. The method of claim 14, wherein the method further comprises adding a basic alkaline cleaning agent with the composition to remove the soil.

19. The method of claim 14, wherein the composition is applied to the surface at temperature of between about 50° F. and about 200° F.

20. The method of claim 14, wherein the composition shows an improved soil removal in comparison to detergent and/or cleaning compositions free of the insoluble solvent.
